(19) United States
(12) Patent Application Publication
(10) Pub. No.: US 2008/0194406 A1
(43) Pub. Date: Aug. 14, 2008

(54) METHOD FOR TREATING AGRICULTURAL CROPS USING MATERIALS ASSOCIATED WITH TUBULAR CARRIERS

(75) Inventors: Ronald R. Price, Stevensville, MD (US); Aaron Wagner, Rochester, NY (US)

Correspondence Address: BASCH & NICKERSON LLP, 1777 PENFIELD ROAD, PENFIELD, NY, 14526, US

(73) Assignee: NaturalNano, Inc., Pittsford, NY (US)

(21) Appl. No.: 11/551,115

(22) Filed: Oct. 19, 2006

Related U.S. Application Data
(60) Provisional application No. 60/728,939, filed on Oct. 22, 2005.

(51) Int. Cl. A01N 25/28; A01P 3/00; A01P 13/00; A01P 15/00; A01P 17/00

(52) U.S. Cl. 504/116.1; 424/408

(57) ABSTRACT

Disclosed are compositions and methods for treating agricultural materials, crops and the like using materials associated with tubules, and more particularly to the controlled or timed release of such materials or agents as a function of the association with halloysite or other mineral-derived nanotubes.

This application claims priority and the benefit, under 35 U.S.C. §119, from US. Provisional Application 60/728,939, for an “AGRICULTURAL APPLICATIONS FOR HALLOYSITE CONTROLLED RELEASE,” filed Oct. 22, 2005 by Ronald R. Price et al., which is hereby incorporated by reference in its entirety.

The present invention relates to a method for treating agricultural crops using materials associated with tubules, and more particularly to the controlled or timed release of such materials or agents as a function of the association with halloysite or other mineral-derived nanotubes.

### BACKGROUND AND SUMMARY

Agriculture often involves the use of various chemicals to enhance plant growth, deter pests, eliminate plants (either selectively or in gross), or selectively eliminate fungi. Other uses of agricultural chemicals will be recognized by those skilled in the art.

It would be desirable to provide methods and compositions to more effectively distribute agricultural chemicals. For example, it would be desirable to have a delivery composition in which the components of the composition that act as carriers for the active ingredients have no long-term effect on the growth environment. It is also believed to be desirable to employ methods and compositions that provide a controlled release of a chemical agent(s) or chemical(s) therein. Accordingly it is further desirable to have methods and compositions for effectively distributing agricultural and chemical compositions that reduce the potential exposure to the chemicals of the person(s) who is applying the chemicals, or to increase the manner in which such chemicals may be applied. Controlled release of active agents using nanotubes was reported by Price, et al., in U.S. Pat. No. 5,651,976, which is hereby incorporated by reference in its entirety.

One object of the invention to provide methods and compositions for providing chemicals, particularly agricultural chemicals, that have one or more of the advantages described above. The invention provides novel agricultural applications for mineral-derived microtubes or nanotubes. In one aspect, agricultural applications of the invention include the use of the mineral-derived microtubes in combination with at least one agricultural or chemical agent. The invention further provides compositions for these applications.

In one embodiment, the mineral microtubes or nanotubes are generally hollow or have an open region therein. Such materials may be selected from a group of materials that, to at least some extent, exhibit naturally-occurring tubular structures, including halloysite, cylindrite, boulangerite, and imngolite. In a further aspect of the invention, the microtubes have inner diameters between about 0.1 μm to about 20 μm. Microtubes may have a pore volume of about 0.23 to about 0.34 ml/g. In a further embodiment of the invention, the active agent may be selected from pesticides, herbicides, fertilizers, antibiotics, antihelmetics, antifouling compounds, dyes, enzymes, peptides, bacterial spores, fungi, hormones, and drugs. Furthermore, compositions of the invention may include one or more additives such as colorants, antioxidants, emulsifiers, carriers, surfactants, and mixtures or combinations thereof.

In a further aspect of the invention, the composition includes an approximate ratio of active agent to mineral-derived microtubes (by weight) of 0.25:1, 1:1, 2:1, 3:1, 4:1, and 5:1. In a further aspect of the invention, compositions of the invention include an approximate ratio of active agent to mineral-derived microtubes of between about 1×10⁻⁶:1 to about 10:1.

In a still further aspect of the invention, the compositions of the invention provide an active agent in an extended release profile. For instance, a single application of an inventive composition may provide effective release of an active agent for about one week, about two weeks, about three weeks, about one month, or about six months.

Mineral-derived microtubes used in compositions of the invention that are halloysite may include, for example, crude halloysite, refined halloysite, or mixtures thereof. Refined halloysite may be, but is not limited to, exfoliated halloysite. Mineral-derived microtubes may be lipophilic or, with treatment, hydrophilic.

The invention provides multiple methods of administration of compositions of the invention. For example, compositions of the invention may be applied by irrigation system, by crop duster, by agricultural sprayer, by fertilizer spreader, or by a combination of methods. Compositions may be delivered by spray nozzle, as dispersible granules, as a liquid suspension, or in a dust-like consistency.

In a still further aspect of the invention, the composition provides at least one herbicide trapped in mineral-derived microtubes. The herbicide may be trapped by sorption.

In a preferred embodiment of the invention, the active agent is an herbicide. The herbicide may be a pre-emergent herbicide. A composition of the invention including an herbicide may be adhered to one side of a plastic barrier film for agricultural use. In a further aspect, the active agent is a pesticide. Microtubes of the invention and/or polysaccharide-coated microtubes of the invention may, for example, be a base for a WG (water-dispersible granule) composition or a WP (wettable powder) formulation.

Microtubes of the invention may be included in capsules. Capsules may be uniform or non-uniform in thickness, diameter, and coverage, both on an individual basis and as a population. Capsules may be comprised of, for example, polysaccharides and/or polyethylene imines. One polysaccharide that may be used is chitosan. Preferably, a substance used to form a capsule will have a cationic charge, allowing electrostatic adherence to and distribution on mineral-derived microtubes with a negative surface charge. A capsule may reduce exposure to an active agent by a person preparing and distributing the compositions of the invention. Multiple layers may further reduce exposure.

A substance used to form a capsule may be selected to attract a pest to be killed by the active agent. This may add or enhance an “attract and kill” utility that may be provided by sexual attractants as additives. A sexual attractant may be, but is not limited to, one or more pheromones. Capsule substances may also be selected to leave particulate matter on small hairs on insects. Insects may groom, consuming the substance including the active agent. In high concentration, compositions of the invention may be irritating to an insect.

In a further aspect of the invention, a capsule material adhered by electrostatic force to a mineral-derived microtubule is secured by a gel envelope. This gel envelope may mask the active agent from the environment. In a further aspect, a composition of the invention may be used to provide an even distribution and/or prolonged activity of, for example, pesticide or herbicide.

In a further aspect of the invention, the active agent is an antibiotic. Encapsulated microtubes including an active agent may be used to reduce dosing requirements and/or side effects. For example, they may offer prolonged release, aid product stability, and aid retention to a surface or organism.

Disclosed in embodiments herein is a method for treating an agricultural crop, comprising: encapsulating at least one active agent for crop treatment in tubules; causing the aggregation of a plurality of tubules having the active agent encapsulated therein into granules; distributing the granules to the crop; and effecting the controlled release of the active agent to the agricultural crop.

Further disclosed in embodiments herein is a method of preparing a controlled release composition for agricultural use, comprising: premixing an active agent and mineral-derived tubules to associate the active agent with the tubules and creating treated tubules; and distributing the treated tubules to an environment, whereby the active agent is eluted to the environment.

Also disclosed in embodiments herein is a method of preparing an active agent for controlled delivery via elution, comprising: encapsulating at least one active agent in tubules to form treated tubules; causing the aggregation of a plurality of treated tubules having the active agent encapsulated therein into granules; applying the granules to an environment; and effecting the controlled release of the environment via elution, wherein the active agent is released from said treated tubules as a function of an environmental stimulus.

### BRIEF DESCRIPTION OF THE DRAWINGS

FIGS. 1A, 1B and 1C include electron micrographs of mineral-derived microtubes and nanotubes in accordance with an embodiment of the invention.

FIG. 2 illustrates, graphically, a characterization of coating retention versus time, to illustrate the level of applied pesticide with pesticide entrapped in mineral-derived tubules.

FIG. 3 includes a graph of furanone release from compositions of the invention.

FIGS. 4 and 5 graphically depict tetracycline release and khellin release over time for compositions representing embodiments of the invention.

The various embodiments described herein are not intended to limit the invention to those embodiments described. On the contrary, the intent is to cover all alternatives, modifications, and equivalents as may be included within the spirit and scope of the invention as defined by the appended claims.

### DETAILED DESCRIPTION

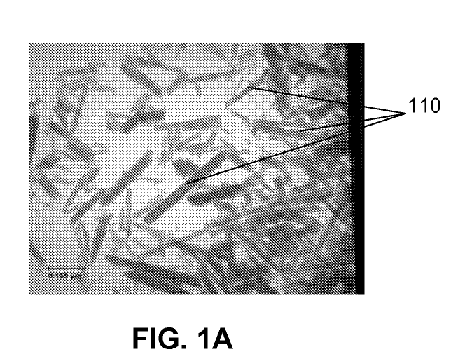

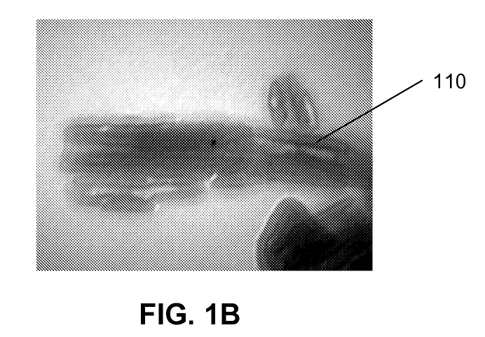

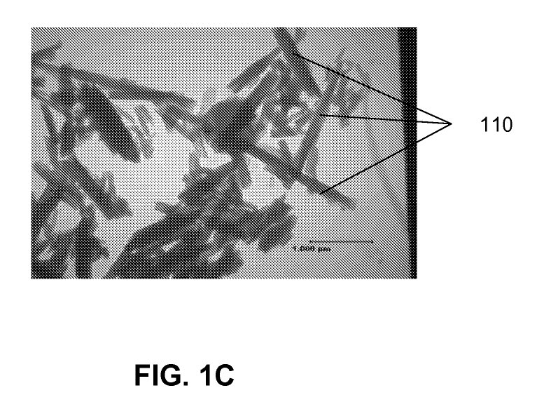

As more particularly set forth below, several embodiments of the disclosed methods and related compositions are directed to treating agricultural crops using materials associated with microtubes or nanotubes (e.g., halloysite and similar materials)—collectively referred to hereinafter as “tubules,” as in very small tubes or tubular or tubular-like structures. FIGS. 1A through 1C are photomicrographs, taken at varying resolutions, of mineral-derived tubules as employed in accordance with aspects of the disclosed method and compositions. For example, in the figures, tubules (110) are scroll-like tubules formed as a result of a bilayered structure, such as that found in halloysite. Attention is now directed to the description of exemplary compositions of mineral-derived tubules and associated active agents for agricultural and related uses, methods of preparing such compositions, as well as methods of applying such compositions.

The advantages of such compositions may include safety and effectiveness for use on products meant for eventual consumption. They may be made from naturally occurring or organic and other environmentally-friendly materials. Such compositions may also provide an extended efficacy due to a controlled and/or extended release profile of an agent in the composition. They may also provide beneficial pH modification to areas upon which they are distributed (e.g., the agents or tubule carriers themselves, may impact the pH of the soil or other environment (e.g., lake or pond) to which they are applied. In one embodiment, for example, the composition may permit the controlled release of pH balancing chemicals into surrounding soil or water—thereby counteracting the effect of acid rain or other environmental contaminants.

Compositions of the invention comprise at least one mineral-based tubule (110) and at least one active agent. One such mineral tubule that is naturally occurring is halloysite nanotubes. Halloysite clay is an aluminosilicate with a formula of Al₂Si₂O₅(OH)₄2H₂0 in its hydrated form. It is believed that tubules are formed during weathering of native hydrated clay where the aluminosilicate forms a bilayer structure of distinct alumina and silica layers. The clay consists of subsequent bilayers held together by an intercalated water layer. One of the consequences of this bilayer structure is that the alumina layer and the silica layer differ in lattice structure, alumina being octahedrally bonded and silica being tetrahedrally bonded, where the lattice mismatch causes otherwise planar sheets of halloysite to curl in on itself and forming a scroll-like tubule (see FIG. 1B). Other mineral-derived nanotubules that may be useful in the invention include, for example, but are not limited to cylindrite, boulangerite, imogolite, as well as mixtures thereof.

Halloysite nanotubes typically range in length from about 100 nm to about 40 microns with an average, though dependent on the natural source, around about 1.2 microns. Inner diameters range from about 20 nm to about 200 nm with an average of approximately 40 nm, while outer diameters range from about 100 nm to about 500 nm, with an average of 200 nm. Native halloysite is a hydrated clay with an intercalated water layer giving a basal spacing of about 10 Å. Subsequent drying of the clay can lead to the dehydrated form of the clay where the intercalated water has been driven off and the basal spacing reduced to 7 Å. Dehydration is a naturally irreversible process, though researchers have had some success with artificially dehydrating the tubes with a potassium acetate treatment. In the hydrated form, the intercalated water can be substituted out for small cations. These small cations may include, for example, organic molecules and the organic molecules may include glycerol.

In various embodiments of the invention, the halloysite may be used in crude or refined form. For present purposes, crude form halloysite is substantially unrefined. Refined halloysite means crude halloysite that has been altered through physical or chemical process resulting in either an increased nanotube content or has de-agglomerated the crude halloysite. These physical or chemical processes may include technologies such as air or water separation, flotation, dry or wet milling, treatment with sodium metahexaphosphate, citric acid, oxalic acid or other treatments known to those of skill in the art. Mineral-derived nanotubules used in the compositions of the invention that are halloysite may be, for example, crude halloysite, refined halloysite, synthetically-derived halloysite or mixtures thereof. Refined halloysite may be, but is not limited to, de-agglomerated halloysite. Microtubes of the invention and/or polysaccharide-coated microtubes of the invention may, for example, be a base for a WG (water-dispersible granule) composition or a WP (wettable powder) formulation.

High tubule content refined halloysite is particularly useful in the applications set forth herein in view of its high surface area. High surface area within the tubules permits slow and consistent dissolution or elution of materials loaded within a tubule. This permits administration of the agents to the surrounding environment with controlled and extended efficacy and/or extended release profiles.

The tubules may be filled with an agent for elution (e.g. minerals, biocides, antifungal agents, pesticides, etc.), as described, for example, in U.S. Pat. No. 5,651,976 by Price et al., which is incorporated herein by reference in its entirety. For example, filling of the tubes is accomplished via an admixing of active agents with various inert carrier agents and refined halloysite, wherein the admixed material is subjected to a reduced pressure of at least about −27 in Hg, and subsequently returned to ambient pressure. Once filled, the tubules may then be encapsulated via a polyurethane, polysaccharide or other polymer-based micro-encapsulant as known by those of skill in the art. Also contemplated is an embodiment where the tubules, for example halloysite nanotubes, are filled with one or more materials or where multiple compositions act in parallel to provide a plurality of properties or advantages. Such characteristics may be particularly important when used in spray coatings as applied to surfaces and the like—both for temporary treatment and for longer-term or permanent treatment.

Mineral-derived tubules used in the compositions of the invention may also include functionalized nanotubes. Functionalization may include, for example, but is not limited to, treatment with quat compounds such as benzalkonium chloride or cetylkonium chloride, silane coupling agents, titanate coupling agents or other similar agents and compounds known to those of skill in the art. Treatment levels may be from about 10 ppm to about 5 percent by weight.

Many active agents may be selected for use in accordance with the embodiments contemplated herein. For example, active agents may be selected from, but not limited to antispasmodics (e.g., khellin), antibiotics (e.g., tetracycline, Albacilin, Amforol, Amoxicillin, Ampicillin, Amprol, Anaprime, Aureomycin, Aziumycin, Chlortetracycline, Oxytetracycline, Gallimycin, Fulvicin, Garacin, Gentocin, Liquamicin, Lincomix, Nitrofurizone, Penicillin, Sulfamethazine, Sulfapyridine, Fulfathiazole, Sulkamycin), agricultural fungicides (e.g., perchloraz), pesticides such as cypermethrins (e.g., alpha-cypermethrin), Malathion, Spectricide, Rotenone, and miticides, microbiocides (e.g., isothiazolones), scents (e.g., cinnamic aldehydes), repellants (e.g., bird repellant methyl anthranilate), chelating/scale inhibitors (e.g., phosphonates), herbicides (e.g., Tri-Chloro Compounds (Triox, Ergerol), Isothiazoline (C9211), Chlorothanolil (Tuffcide)), antihelmetics (e.g., Ivermictin, Vetisulid, Trichlorofon, Tribrissen, Tramisol, Topazone, Telmin, Furox, Dichlorovos, Anthecide, Anaprime, Acepromazine, Pyrantel Tartrate, Trichlofon, Fabentel, Benzimidazoles, Oxibenzidole), antifouling compounds (e.g., Ergerol, Triazine, Decanolactone, Angelicalactone, Galactilone, any Lactone Compound, Capsicum oil, Copper Sulphate, Isothiazalone, organochlorine compounds, organotin compounds, Tetracyclines, Calcium lonophores such as 504, C23187), dyes, enzymes, peptides, spores, fungii, hormones, drugs, and combinations thereof. Other examples of agricultural compounds include, for example, those described by R. Price et al. in US Patent Publication 20020142022, which is hereby incorporated by reference in its entirety.

Compositions of the invention may include one or more active agents or additives. In one embodiment, multiple additives may be associated with the same tubules, whereas in another embodiment different additives may be associated with separate quantities of tubules and the tubules then intermixed in desired ratios or proportions to achieve a desired composition. For example, it is contemplated that a mineral-based microtubule composition may be created to distribute an herbicide at a first rate and a fertilizer at a second rate, where the first rate is greater than the second rate. Those skilled in the art will, with the benefit of this disclosure, recognize that a number of additives may also be useful in embodiments of the invention. Additives may include one or more colorants, antioxidants, emulsifiers, fertilizers, surfactants, or mixtures thereof. The amount of additive necessary will vary based on the type of additive and the desired effect of the composition including the additive.

The ratio of active agent and/or additive to mineral-derived microtubes (by weight) in the composition may be varied to provide varying levels of efficacy, release profile, and distribution. For example, the composition may include an approximate ratio of active agent to mineral-derived tubules (by weight) between about 1×10⁻⁶:1 to about 10:1, and more particularly about 1:1 to about 5:1.

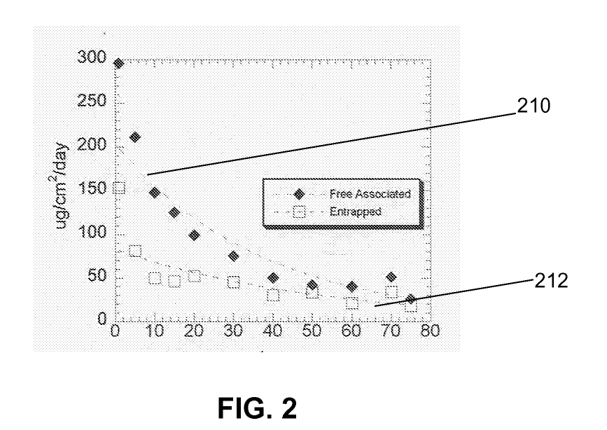

A composition of the invention may provide an active agent or plurality of active agents in an extended or controlled release profile or profiles, where differently prepared compositions may exhibit different profiles and may be used separately or in combination with one another. For example, as depicted in FIG. 2 there is shown a graphical representation of a coating's retention of an active pesticide agent versus time. To illustrate the level of applied pesticide with pesticide entrapped in mineral-derived tubules, the graph of FIG. 2 depicts the level of pesticide for both a pesticide freely associated with a coating (210) and a pesticide entrapped for elution (212). It is contemplated that the particular characteristics of tubules make them particularly suitable for the transmission of pesticides, where the pesticides may be likely to become attached to the animal (insect) coming in contact with the pesticide composition, and where the animal will have prolonged exposure or ingestion (e.g., via grooming) of the composition.

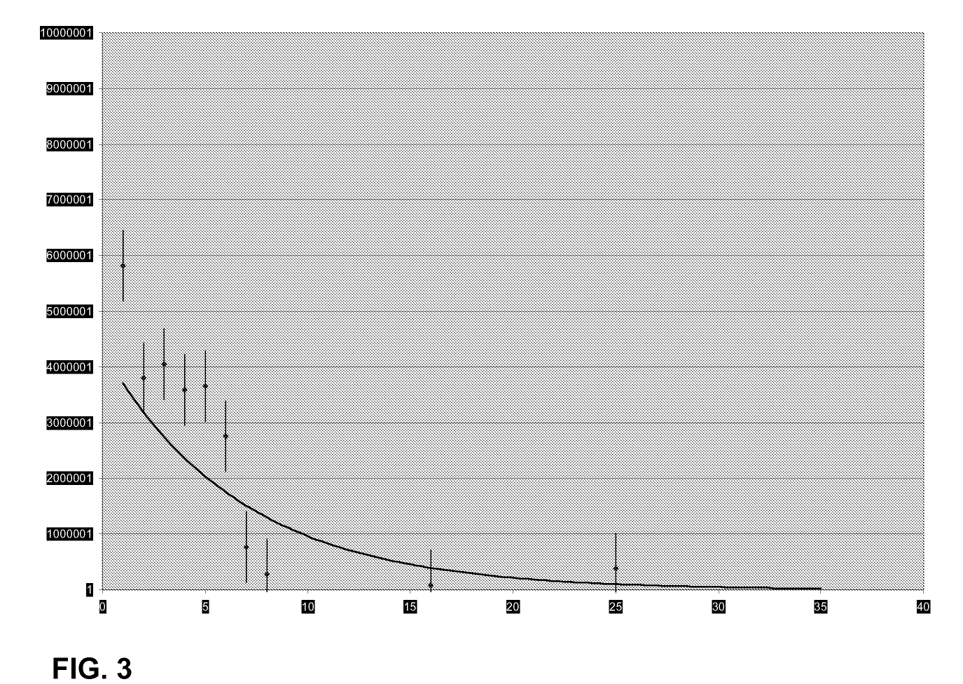

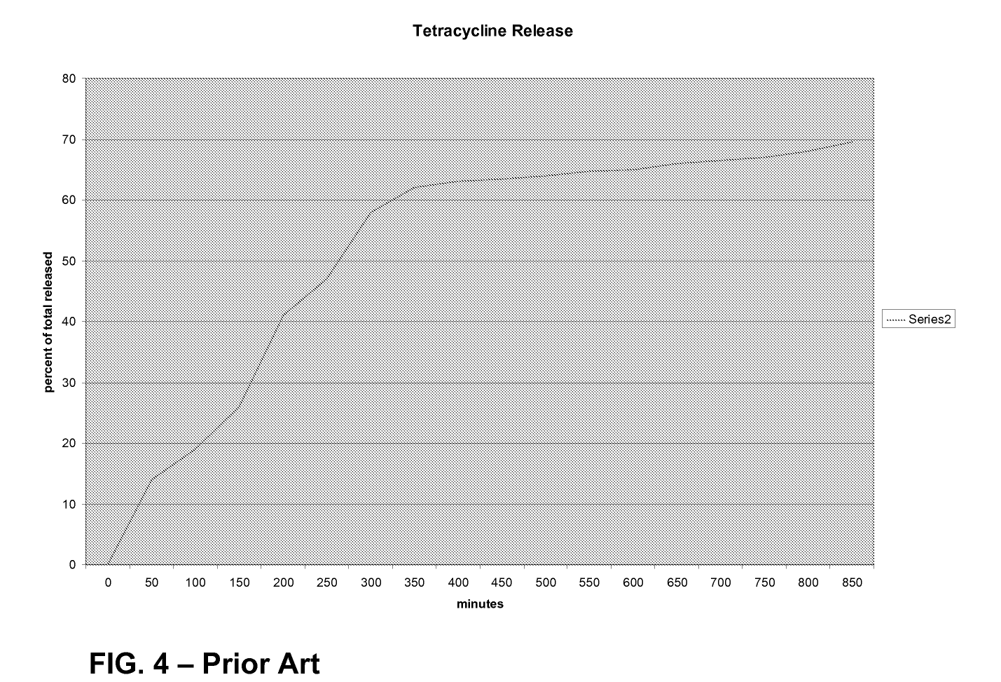

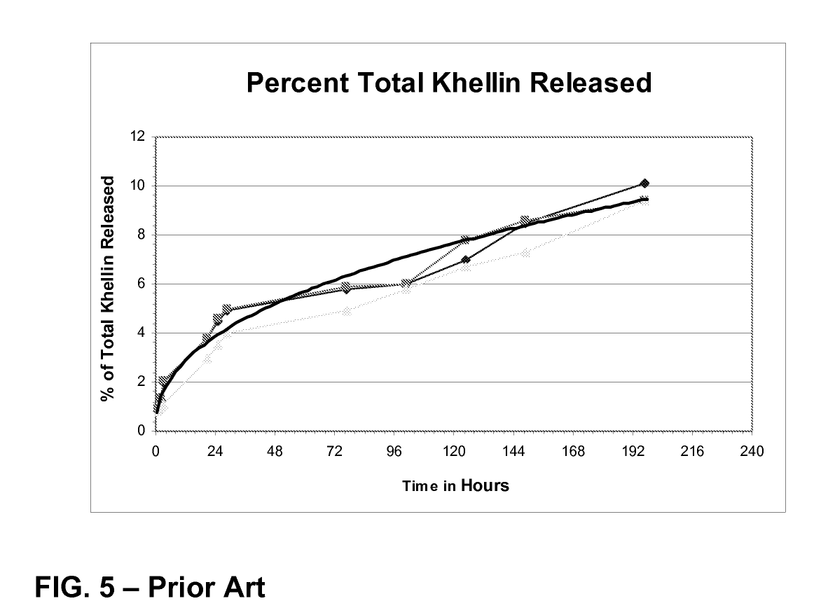

Similarly, FIG. 3 illustrates the rate of release of a fungicide/pesticide (furanone) from compositions prepared using mineral tubules. Such a composition is believed to provide ease of spray-type application, and permit the use of reduced concentrations due to the controlled or extended release rates as depicted in the figure—release over about 15 to 25 days. FIGS. 4 and 5, respectively illustrate, relative to total release amounts, the release profiles for two drugs (Tetracycline and Khellin), wherein prolonged application periods are desired. As indicated in the figures, the release profiles extend for several hours in the Tetracycline example (FIG. 4) and for several days in the Khellin example (FIG. 5). It will be appreciated that the specific release profile is a function of not only the materials (tubules and agents) employed for the composition, but also may be a function of the environment in which applied (moisture/solvent level, temperature, etc.). Also contemplated is usage where a plurality of active agents may be released in a combination of extended release and controlled release profiles. For instance, a single application of a composition of the invention may provide effective activity for at least a first period and a second period, such as about one week, about two weeks, about three weeks, about one month, or about six months. Aspects of the data set forth in the figures, for example, may be found in “In-Vitro Release Characteristics of Tetracycline HCl, khellin and Nicotinamide Adenine Dineculeotide from Halloysite; a Cylindrical Mineral,” by R. Price et al., published in Journ. Microencapsulation, 2001, Vol. 18, No. 6, p. 713-722, which is hereby incorporated by reference in its entirety.

Having described various embodiments for compositions including active agents associated with tubules, attention is briefly directed to the manner in which such compositions may be prepared for application. In one embodiment, the method of application may be a spray or similar liquid-based distribution of tubules within a suspension. It will be appreciated that surfactants or similar materials may be required for such applications. Such an application may include the mixing of the treated tubules with a distribution medium, or the injection of dried tubules into a liquid stream (e.g, a venturi mixing method, high-shear mixing, etc.), so that the liquid medium is used to distribute or apply the treated tubules (e.g., to soil through spraying or irrigation, to plant surfaces directly, or to other surfaces).

As an alternative embodiment, the distribution may occur as granules such as by the application of granules directly to soil, live plant surfaces or application to other surfaces that may come into contact with a target (e.g., a surface coming into contact with crops, with animals or insects, other agricultural materials, etc. In one aspect of the granular distribution embodiment, the granules may include an encapsulating material that coats or otherwise binds a plurality of tubules, in an aggregated group of tubules, with one another. Such a coating or binder may include, for example, polysaccharides (e.g., Chitosan), polyethylene imines, polyethyleneamine and polystyrene sulfonate. As another alternative, the aggregation may be inserted in or covered by a capsule or material.

In order to control the application of active agents using the compositions disclosed herein, it is further contemplated that the aggregations of tubules may be achieved using electrostatic charges or forces to cause groups of generally similar weights or sizes to form as aggregations. Depending upon the nature of the active agent, and/or the manner in which is applied to a crop, environment or even a surface, it may be possible to initiate or control the release of the active agent through one or more environmental stimuli. In one embodiment, the stimuli may initiate the release or elution of the active agents. Stimuli may include, for example, a solvent or other catalyst that initiates or enables elution, as well as heat or similar forms of energy that could produce similar results. In one embodiment, the stimuli may include solvents such as water, acid rain, or others, the breakdown of a barrier or nanotube via the application of energy (heat, ultraviolet light, ultrasonic vibration, compaction, tilling, etc.).

A surface treatment of a composition of the invention may increase affinity of the composition to the surface to which it is being applied or is intended for application. For example, the waxy cuticle of some plant species may need to be protected in some applications, so the composition can be treated to be shed from such regions yet permit water dispersion of the composition as necessary for its application. Compositions of the invention may also be blended to enhance active agent properties—where the combination of active agents results in increased efficacy or other desirable affects that would not be achievable otherwise, or would require the time and expense of serial application of the materials. Similarly, the composition may further include an inert agent for the purpose of modifying the density of the granules (e.g., increasing density to encourage gravity-caused migration to a soil level).

A further aspect of the described embodiment provides a method for imparting active agent properties to an area, an item, or a surface. For example, compositions of the invention may be applied to plant surfaces such as stems and leaves or to edible portions of fruits and vegetables. In one embodiment the method of distributing the composition is accomplished via spreading or broadcasting a granular composition over a grass or lawn, where the composition is prepared so as to ensure consistent granular composition, size and weight so as to permit the efficient and consistent application of such compositions.

The invention further contemplates the use of various encapsulants, binders and the like suitable for preparing the compositions. In particular, one encapsulant that is believed to be practicable is polysaccharide capsules.

The manner of preparation and delivery of the composition, including encapsulation (e.g., granules) and liquid suspension, provides multiple methods of administration for compositions of the invention. Ideally, compositions may be distributed using equipment that is already used by the person applying the compositions. For example, compositions may also be applied using irrigation systems, aerial dispersion (e.g., crop dusting), agricultural sprayers, spreaders, or possibly by a combination of methods. In accordance with the various application methods, compositions and methods may be provided that permit the efficient distribution of one or more active agents. In a still further aspect, the one or more agents are distributed at one or more rates. In a yet further aspect, the one or more agents are distributed at one or more times. This composition may not be limited to agricultural compositions and uses. The composition may include, for example, mineral microtubes, one or more active agents, and optionally, one or more additives.

It is contemplated that the foregoing embodiments are merely exemplary, and that numerous alternative embodiments incorporating the inventive concepts disclosed herein are within the skill of the ordinary artisan who is provided with the benefit of this disclosure.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for treating an agricultural crop, comprising:
encapsulating at least one active agent for crop treatment in tubules;
causing the aggregation of a plurality of tubules having the active agent encapsulated therein into granules;
distributing the granules to the crop; and
effecting the controlled release of the active agent to the agricultural crop.

2. The method of claim 1, where distributing the granules includes application of granules directly to soil.

3. The method of claim 1, where distributing the granules includes application of granules directly upon live plant surfaces.

4. The method according to claim 1, further comprising coating at least part of an aggregation of tubules with an encapsulating material.

5. The method of claim 4, wherein the encapsulating material is selected from the group consisting of: polysaccharides, polyethylene imines, polyethyleneamine and polystyrene sulfonate.

6. The method according to claim 4, further comprising using electrostatic charges to effect the aggregation of tubules.

7. The method of claim 1, wherein the agent being released includes a material selected from the group consisting of: herbicides, pesticides, fungicides, nutrient(s), animal repellants, antispasmodics, antibiotics, miticides, microbiocides, scents, chelating agents, scale inhibitors, antihelmetics, antifouling compounds, dyes, enzymes, peptides, spores, fungii, hormones, and drugs.

8. The method of claim 1, further including applying an environmental stimulus to trigger effecting the controlled release of the active agent.

9. The method of claim 8, wherein the environmental stimulus is selected from the group consisting of:
a chemical triggering agent; and
a physical stimulus.

10. The method of claim 1, wherein causing the aggregation includes enclosing the tubules within a capsule.

11. The method of claim 1 including encapsulating at least a second active agent in the plurality of tubules wherein both active agents are distributed to the crop.

12. A method of preparing a controlled release composition for agricultural use, comprising:
premixing an active agent and mineral-derived tubules to associate the active agent with the tubules and creating treated tubules; and
distributing the treated tubules to an environment, whereby the active agent is eluted to the environment.

13. The method of claim 12, where distributing the treated tubules comprises aggregating the tubules into granules and the application of granules directly to soil.

14. The method of claim 12, where distributing the treated tubules includes the application of tubules directly upon plant surfaces.

15. The method of claim 12, where distributing the treated tubules includes application to non-organic surfaces placed in contact with agricultural materials.

16. The method according to claim 12, further comprising coating an aggregation of treated tubules with an encapsulating material prior to distributing the treated tubules to an environment.

17. The method of claim 12, wherein the active agent includes a material selected from the group consisting of: herbicides, pesticides, fungicides, nutrient(s), animal repellents, antispasmodics, antibiotics, miticides, microbiocides, scents, chelating agents, scale inhibitors, antihelmetics, antifouling compounds, dyes, enzymes, peptides, spores, fungii, hormones, and drugs.

18. The method of claim 12 including encapsulating at least a second active agent in a plurality of tubules wherein both active agents are subsequently distributed.

19. A method of preparing an active agent for controlled delivery via elution, comprising:
encapsulating at least one active agent in tubules to form treated tubules;
causing the aggregation of a plurality of treated tubules having the active agent encapsulated therein into granules;
applying the granules to an environment; and
effecting the controlled release of the environment via elution, wherein the active agent is released from said treated tubules as a function of an environmental stimulus.

20. The method of claim 19, where applying the granules includes application of granules directly to soil.

21. The method of claim 19, wherein the composition further includes an inert agent for the purpose of modifying the density of the granules.

22. The method of claim 19, where applying the granules includes application of granules directly upon plant surfaces.

23. The method according to claim 19, further comprising coating at least part of the granules with an encapsulating material.

24. The method of claim 19, further including applying an environmental stimulus to initiate effecting the elution of the active agent.
